(19) United States
(12) Patent Application Publication
(10) Pub. No.: US 2007/0008059 A1
(43) Pub. Date: Jan. 11, 2007

(54) Misregistration-tolerant overlay inductors

(75) Inventor: Haitao Li, Hillsboro, OR (US)

Correspondence Address: KLARQUIST SPARKMAN, LLP, 121 SW SALMON STREET, SUITE 1600, PORTLAND, OR, 97204, US

(73) Assignee: TriQuint Semiconductor, Inc.

(21) Appl. No.: 11/176,801

(22) Filed: Jul. 6, 2005

(51) Int. Cl. H01F 27/28

(52) U.S. Cl. 336/223

(57) ABSTRACT

Selected dimensions of conductive strips on one or more layers of a multilayer substrate are increased to compensate misregistration effects associated with device fabrication. The increased dimension can be based on one or more factors such as, for example, a likely misregistration distance. In one embodiment, conductive strips from two different conductor layers follow a common path and are electrically connected by a via to provide an overlay inductor. The conductive strip in one conductor layer is made slightly wider that the conductive strip of the other conductor layer to reduce the effects of misregistration on electrical characteristics.

### TECHNICAL FIELD

The present application concerns electronic circuits, particularly multilayer circuits.

### BACKGROUND

Inductors are often used in modem electronic devices. One example of such a device is the cellular phone, which employs inductors for components such as an output matching network in a power amplifier module (PAM). Many such matching networks use transmission line inductors, based on transmission lines formed in part as, for example, microstrip, stripline, or coplanar waveguides. Such inductors can be formed in multilayer substrates as microstrip inductors defined in a top metal layer or in a buried metal layer inside a substrate. An overlay inductor uses multiple layers of microstrip conductors to create a transmission line in approximately spiral form. Sections of microstrip conductors in a given layer can be referred to as “traces,” and mutual coupling among traces often provides increased inductance in less space than other inductor types. Layers of conductors are separated from each other by layers of dielectric material such as a solid core, or a pre-impregnated fabric (“prepreg”) or other material. Dielectric materials vary in thickness, but a thickness of about 100 μm is common. The benefits of using microstrip transmission lines to define inductors include: lower loss (compared to chip inductors); smaller size (compared to coil inductors); and adaptability to irregular shapes to use circuit area efficiently.

Referring to FIG. 1, a microstrip overlay inductor 110 is defined by overlapping sections of conductors 106, 108 that are defined in respective layers of a multilayer circuit 100. The conductors 106, 108 are typically separated by one or more dielectric layers that are not shown in FIG. 1. For convenience in illustration the conductor section 106 is shown with a solid line, and the conductor section 108 is shown with a dashed line. An overlap region 102 defined by the conductors 106, 108 is shown with hatch marks, and such an overlap region is generally selected to provide a predetermined inductance. Conductors from different layers, such as the conductors 106, 108 can be connected by a via such as via 113. A second microstrip inductor 120 is also shown in FIG. 1. The inductor 120 includes sections of conductors 124, 126 that are situated to provide an overlap area 128. FIG. 2 is an electrical schematic diagram illustrating the placement of overlay inductors such as the overlay inductors 110, 120 in an impedance matching network 130.

Circuit features defined in different layers of a multilayer board must be fabricated to provide precise alignment to, for example, obtain a selected inductance. Unfortunately, precise alignment of features on different layers is difficult to achieve and typically circuit features are misaligned or “misregistered” due to imperfect fabrication processes. Accordingly, improved overlay inductors and methods of fabrication are needed. This problem is representative of problems that may be solved by some and not necessarily all embodiments of the technology described herein, and other problems not discussed in interests of brevity may also be addressed by the disclosed technology.

### BRIEF DESCRIPTION OF THE DRAWINGS

FIG. 1 is a plan view of a multilayer substrate that includes overlay inductors.

FIG. 2 is an electrical schematic diagram illustrating an impedence matching network.

FIG. 3A is a plan view of a circuit element defined by offset conductive strips.

FIG. 3B is a sectional view of the circuit element of FIG. 3A.

FIG. 4A is a plan view of a circuit substrate used to define overlay inductors.

FIGS. 4B-4C are plan views of overlay inductors illustrated in FIG. 4A.

FIG. 5 is a sectional view of offset conductive strips having different effective widths.

FIG. 6 is a plan view of offset conductive strips having varying effective widths.

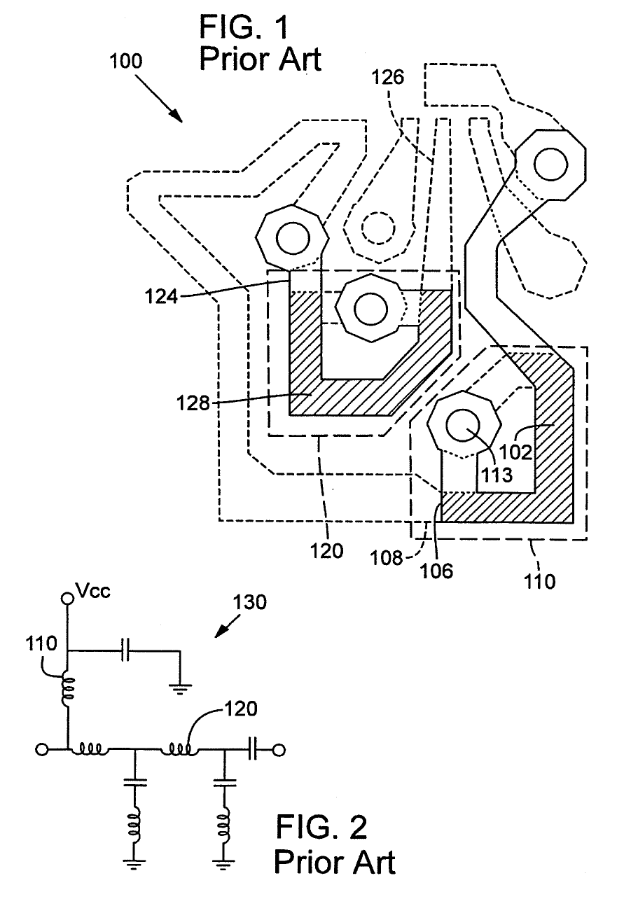

### DETAILED DESCRIPTION

Disclosed below are representative methods and apparatus. The disclosed methods should not be construed as limiting in any way. Instead, the present disclosure is directed toward novel and non-obvious features and aspects of the various disclosed embodiments, alone and in various combinations and sub-combinations with one another. The methods and apparatus are not limited to any specific aspects or features, or combinations thereof, nor do the methods and apparatus require that any one or more specific advantages be present or problems be solved.

Although the operations of the disclosed methods and apparatus are described in a particular, sequential order for convenient presentation, it should be understood that this manner of description encompasses rearrangement, unless a particular ordering is required by specific language set forth below. For example, operations described sequentially may in some cases be rearranged or performed concurrently. Additionally, the detailed description sometimes uses terms like “determine” and “identify” to describe the disclosed methods. These terms are high-level abstractions of the actual operations that are performed. The actual operations that correspond to these terms will vary depending on the particular implementation and are readily discernible by one of ordinary skill in the art.

In selected examples, circuit elements such as resistors, capacitors, and inductors are formed in multilayer substrates. Such substrates typically include one or more conductive layers that are spaced apart by one or more dielectric layers. Circuit elements can be defined by patterning conductive strips in one or more of the conductive layers. The conductive strips can be referred to as microstrips, and portions or sections of such strips can be associated with circuit element definition while other portions are configured to electrically couple circuit elements. For example, a capacitor can be defined by a section of a first strip in a first conductive layer and a section of a second strip in a second conductive layer. The sections of the first strip and the second strip can be oppositely situated with respect to a dielectric layer situated between the first and second conductive layers. Widths of the sections can be selected to provide a predetermined capacitance, while dimensions of other portions of the first and second strips are selected to provide, for example, convenient electrical connections, a selected resistance, electrical waveguide propagation, or other properties or characteristics.

For convenient implementation of circuit elements, strip sections that define a circuit element can be situated in different layers, and aligned substantially parallel to a common path that can be defined in a plane parallel or substantially parallel to the layers. In some examples, the common path is linear, curved, or includes a plurality of linear and/or curved sections. In one example, a common path is configured to provide a spiral shape or a spiral-like shape defined by two or more linear segments. While multilayer circuits are typically defined in substantially planar layers, such circuits can be defined on curved surfaces as well. In such examples, a common path is typically defined in a surface that is locally parallel to curved layer surfaces. While strip sections can be linear in some examples, such strip sections are referred to herein as “traces” to further indicate that strip sections can be curved, straight, or have multiple curved and/or linear sections.

Conductive or other strips can have varying widths. Because a typical strip or strip section used in a particular circuit element follows a path that is not necessarily linear, strip section width is typically referred to herein as “effective” width to reflect that a strip width can be associated with strip dimensions measured in different or changing directions. Typically, effective width is associated with a dimension that is substantially orthogonal to a local axis of a common path. Example overlay inductors include conductive strips, but in other examples, other circuit elements or circuit features can be at least partially defined with dielectric strips.

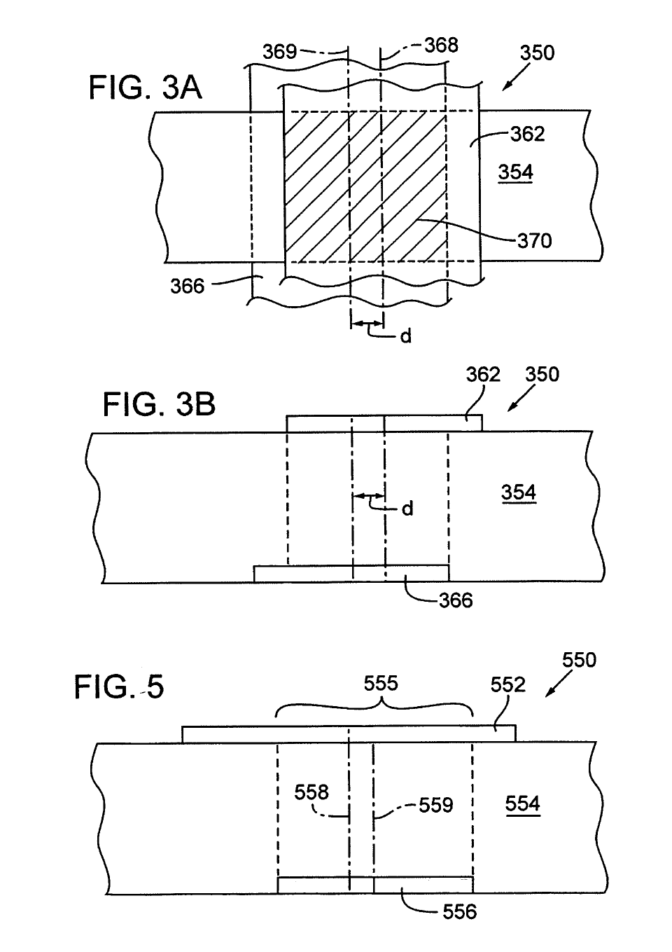

With reference to FIGS. 3A-3B, a circuit feature 350 includes a conductive trace 362 defined in a first metal layer and a conductive trace 366 defined in a second metal layer. The first and second metal layers are typically separated by one or more dielectric layers such as a dielectric layer 354. The conductive traces 362, 366 extend along respective center axes 368, 369 that are substantially parallel but offset by a distance d. The conductive traces 362, 366 typically include one or more substantially straight sections, and each or some of these sections of the conductive traces 362, 366 can be offset by different distances from corresponding sections of the conductive traces 366, 362, respectively. For convenience, only a single, linear section is shown in FIGS. 3A-3B. Curved offset sections can also be used, and selection of either curved or straight line sections is typically based on fabrication convenience.

Performance parameters associated with circuit features such as the circuit feature 350 depend on a size of a “common area” between corresponding sections of conductive traces defined on different layers. As shown in FIGS. 3A-3B, the conductive traces 362, 366 define a common area 370 based on widths of the conductive traces 362, 366 and the offset distance d. A performance parameter of the circuit feature 350 such as an inductance of an overlay inductor can be selected based on selection of the offset distance d. Increasing the offset distance tends to reduce an overlay inductance. In some examples, layer-to-layer offsets of conductive traces by 25 μm to 50 μm can produce significant inductance changes, and can be used to, for example, provide an appropriate inductance for a matching network of a power amplifier.

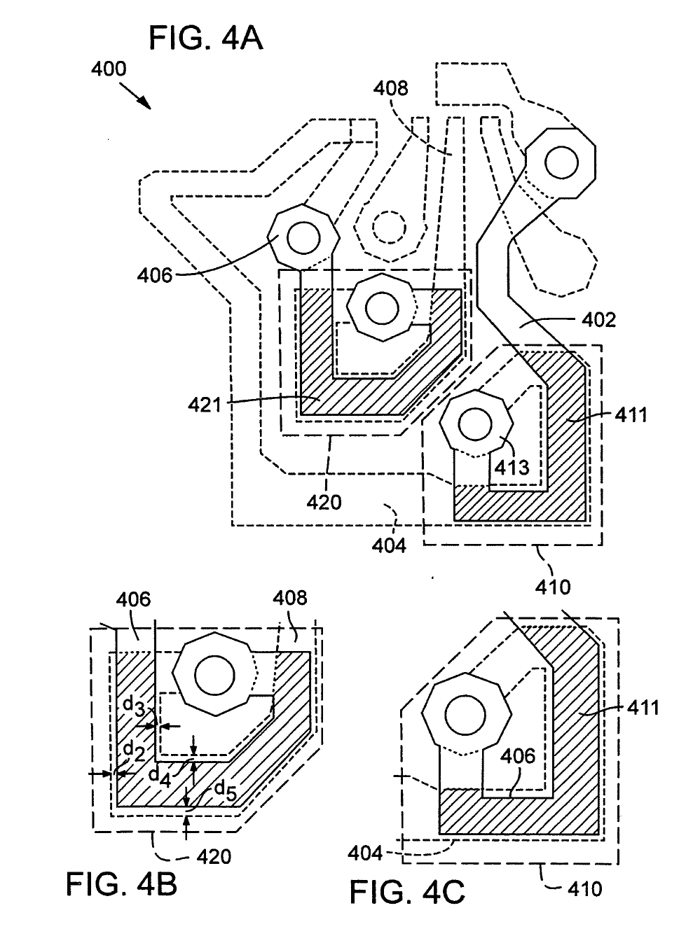

FIGS. 4A-4C illustrate portions of a multilayer circuit 400 that define overlay inductors 410, 420 that are defined by respective sections of conductive traces 402, 404 and 406, 408. As shown in FIGS. 4A-4C, the conductive traces 402, 406 are formed in a first conductor layer, and the conductive traces 404, 408 are defined in a second conductor layer. The first and second conductor layers are separated by one or more dielectric layers (or other layers) that are not shown in FIGS. 4A-4C. The sections of conductive traces that define the overlay inductors 410, 420 are configured to establish respective overlap areas 411, 421 that are shown if FIGS. 4A-4C with hatch marks. In the example of FIGS. 4A-4C, the sections of the conductive traces 404, 408 in the second conductor layer are generally wider in an x-dimension, in a y-dimension, or in both an x- and a y-dimension than the corresponding sections of the conductive traces 402, 406 of the first conductor layer. For example, as shown in FIG. 4B, conductive traces 406, 408 of the inductor 420 generally follow a common path but are of unequal widths. Similarly, FIG. 4C shows that conductor traces 402, 404 generally follow a common path, but the conductive trace 404 is wider than the conductive trace 402. Thus, overlap areas 411, 421 are defined by a width of the narrower conductor trace, and are relatively insensitive to trace offsets. For example, as shown in FIG. 4B, offsets d₂, d₃, d₄, d₅ of edges of the conductive traces 406, 408 do not produce variations in the overlap area 421. Thus, despite misregistration, a predetermined overlap area can be obtained. Thus, providing a wider conductor trace permits realization of an intended inductance (or capacitance or other circuit parameter) even in the presence of offsets introduced by fabrication errors. A representative example is illustrated in FIGS. 4A-4C, but widths of conductor traces in either a first layer or a second layer can be increased to decrease inductance or capacitance sensitivity to conductive trace offsets.

The multiplayer circuit of 4A-4C includes sections of conductor traces that are configured to compensate for misregistrations in more than one direction. However conductor trace offsets in a single direction can also be compensated by increasing a width of a conductor section in one direction. A suitable increase in trace width can be determined in several ways. One approach is to increase the dimension of the trace by approximately an expected misregistration, which in some fabrication processes, can be as much as about 25 μm or 50 μm, for example. Other fabrication process characteristics can also be used. For example, a trace dimension can be increased as a percentage of an original, uncompensated value. For example, some conductor sections can have widths that are compensated by increasing trace widths in one or more layers to 110%, 125%, 150%, or 200% of the original uncompensated value. One limiting factor in increasing the trace widths is the proximity of a particular trace to other traces. For example, as shown in FIG. 4A, increasing the width of a trace in inductor 420 may bring the trace into close proximity with traces in inductor 410, causing undesired coupling. For closely spaced conductor sections, a width of a selected conductor can be increased less than an amount of a registration error. While such an increase does not eliminate circuit value variations due to routine fabrication tolerances, misregistration effects are reduced, even if overlap area remains somewhat dependent on conductor alignment.

FIG. 5 is a sectional view of a circuit feature 550 that has been adjusted for misregistration. Centerlines 558, 559 of conductor traces 552, 556, respectively are offset. A width of the conductive trace 552 is greater than a width of the conductor trace 556. An overlap area 555 is based on the width of the conductor trace 556 and remains unchanged by the offset of the centerlines 558, 559. While larger offsets can reduce the overlap area 555, electrical properties of the circuit feature are more tolerant to offsets than corresponding features defined using a common trace width for all conductors.

Designs for circuits and circuit elements that include such compensated dimensions or selected offsets can be obtained using a CAD tool and stored on computer-readable media in any suitable file format, such as the Gerber file format. Additionally, automated design tools can carry out one or more processes which implement the ideas and principles described in this application. For example, an automated design tool may identify elements in a given circuit layout that may be unacceptably sensitive to misregistration error, such as overlay inductors for power amplifier matching networks. The automated design tool can then identify traces on one layer that should overlap other layers. The automated design tool can adjust trace dimensions of selected conductor sections to compensate, or partially compensate misregistrations while maintaining acceptable trace separation on a particular layer.

Although the described embodiments pertain to microstrip circuits with overlay inductors comprising conductor traces defined in two metal layers, the principles of the described technology may be applied to other circuits based on traces defined on three or more metal or other layers of metal and along with additional dielectric layers. When traces in three or more layers are subject to misregistration, dimensions of traces in one or more layers can be adjusted.

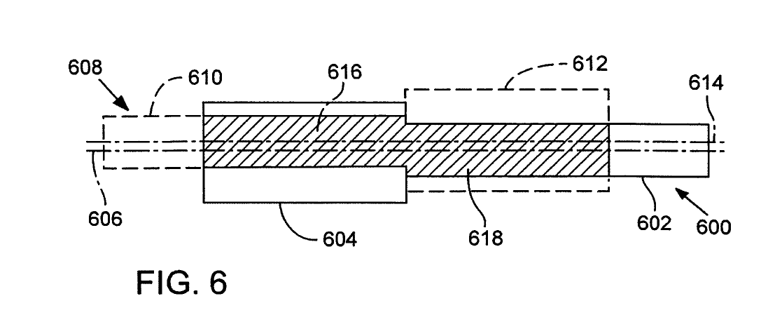

In additional examples, strip section widths can be selected so that portions of a strip section in a first layer are wider than a corresponding portion of a strip section in a second layer while other portions of the strip section in the first layer are narrower than corresponding portions in the second layer. Referring to FIG. 6, a multilayer circuit includes a first conductive strip 600 and a second conductive strip 608 that are defined in a first conductor layer and a second conductor layer, respectively. The first and second conductor layers are spaced apart with at least one dielectric layer that is not shown in FIG. 6. The first conductive strip 600 includes a first section 602 and a second section 604 that are situated along an axis 606. The second conductive strip 608 includes a first section 610 and a second section 612 that are situated along an axis 614. Effective widths of the strip sections 604, 612 are greater that effective widths of strip sections 610, 602, respectively. The strip sections 604, 610 define a first overlap area 616 and the strip sections 602, 612 define a second overlap area 618. A total overlap area that is typically associated with a circuit element property (such as inductance) is based on the combined overlap area established by the first overlap area 616 and the second overlap area 618.

As noted above, increasing a trace effective width or controlling a trace offset can be used to select or control electrical properties of circuit elements such as overlay inductors and capacitors. In addition, non-metal layers and elements such as vias may be similarly adjusted to compensate for misregistration error. Such circuit elements can be incorporated into electronic devices, including, but not limited to cell phones, digital radios, optical networking devices, cellular base stations, radar systems, power amplifiers, matching networks, and similar devices.

In view of the many possible embodiments to which the principles of the disclosed technology may be applied, it should be recognized that the illustrated embodiments are only preferred examples and should not be taken as limiting application of the technology. The scope of the invention is defined by the following claims and equivalents thereto. I therefore claim as my invention all that comes within the scope and spirit of the appended claims.

I claim:

1. A circuit element, comprising:
a substrate that includes a first layer having a first trace defined therein and a second layer having a second trace defined therein, wherein the first trace and the second trace are situated along a common path, wherein an effective width of at least a first portion of the first trace is greater than an effective width of a corresponding first portion of the second trace; and
a third layer situated between the first layer and the second layer.

2. The circuit element of claim 1, wherein the effective width of the first trace is greater than an effective width of the second trace.

3. The circuit element of claim 1, wherein an effective width of at least a second portion of the first trace is less than an effective width of a corresponding second portion of the second trace.

4. The circuit element of claim 1, wherein the first layer and the second layer are conductor layers.

5. The circuit element of claim 4, wherein the third layer is a dielectric layer.

6. The circuit element of claim 5, wherein the first trace and the second trace are configured to define an overlap inductor.

7. The circuit element of claim 1, wherein the effective width the first trace is based on a fabrication process tolerance.

8. The circuit element of claim 6, wherein the effective width of the first trace is at least about 25 μm greater than the effective width of the second trace.

9. The circuit element of claim 6, wherein the effective width of the first trace is at least about 50 μm greater than the effective width of the second trace.

10. The circuit element of claim 6, wherein the common path has portions directed along orthogonal axes within a plane.

11. The apparatus of claim 1, wherein the first trace and the second trace are electrically connected by a via.

12. The circuit element of claim 1, wherein the effective width of the first trace, the effective width of the second trace, and the common path are selected to obtain a predetermined overlap area associated with a circuit characteristic of the circuit element.

13. A fabrication method, comprising:
selecting a common path associated with a predetermined electrical characteristic;
defining a first layer that includes at least a first trace extending along the common path;
defining a second layer that includes at least a second trace extending along the common path; and
situating a third layer between the first and second layers, wherein an effective width of at least a portion of the first trace is greater than an effective width of a corresponding portion of the second trace.

14. The method of claim 13, wherein the first layer and the second layer are conductive layers and the third layer is a dielectric layer.

15. The method of claim 13, wherein at least one of the effective width of the first trace and the effective width of the second traces is selected based on a fabrication tolerance associated with trace offsets from the common path.

16. The method of claim 15, wherein the common path and the effective trace widths are selected to provide a predetermined inductance.

17. A computer-readable medium containing instructions that, when executed by a computer, perform the method of claim 16.

18. A computer-readable medium containing instructions that, when executed by a computer, perform the method of claim 13.

19. An inductor, comprising:
a first trace defined in a first conductive layer;
a second trace defined in a second conductive layer, wherein the first trace and the second trace extend along a common path, and wherein an effective width of the first trace is greater than an effective width of the second trace.

20. An impedance matching network, comprising:
at least one capacitor; and
an inductor as recited in claim 19, wherein the inductor is in electrical communication with the capacitor.

21. A mobile communication device, comprising:
an impedance matching network as recited in claim 20; and
a power amplifier electrically coupled to the impedance matching network.

22. A method, comprising:
selecting an overlap area between a first trace and a second trace based on a predetermined electrical characteristic; and
offsetting the first trace and the second trace to obtain the selected overlap area.

23. The method of claim 22, further comprising selecting a common width for the first trace and the second trace.

24. The method of claim 22, wherein an effective width of the first trace is substantially different from an effective width of the second trace.

25. The method of claim 22, wherein the predetermined electrical characteristic is an inductance.
